(19) United States
(12) Patent Application Publication
(10) Pub. No.: US 2026/0105883 A1
(43) Pub. Date: Apr. 16, 2026

(54) MULTI-FRAME IMAGE LOADING FOR DIGITAL DISPLAYS

(71) Applicant: X Display Company Technology Limited, Dublin (IE)

(72) Inventors: Imre Knausz, Fairport, NY (US); Matthew Alexander Meitl, Durham, NC (US); Ronald S. Cok, Rochester, NY (US)

(21) Appl. No.: 19/256,251

(22) Filed: Jul. 1, 2025

Related U.S. Application Data
(60) Provisional application No. 63/666,898, filed on Jul. 2, 2024.

(51) Int. Cl. G09G 3/32

(52) U.S. Cl. CPC G09G 3/32; G09G 2320/10; G09G 2330/021; G09G 2340/0435; G09G 2350/00

(57) ABSTRACT

A digital display includes an array of display pixels and a display controller operable to receive a sequence of images send pixel values from the images to the display pixels. Each of the display pixels includes a light emitter and a pixel circuit operable to receive and store pixel values from the display controller in a pixel memory and control the light emitter to emit light corresponding to the pixel values. Each image pixel value is a multi-bit pixel value comprising first bit(s) and second bit(s) and the display controller is operable to send the first bit(s) to the display pixels and then send the second bit(s) to the display pixels. The display pixels are operable to receive and store the first bit(s) in the pixel memory, display the stored pixel value, receive and store the second bit(s) in the pixel memory, and then display the stored pixel value.

### PRIORITY APPLICATION

The present application claims priority from U.S. Provisional Ser. No. 63/666,898, entitled “Multi-frame image loading for digital displays”, filed on Jul. 2, 2024, the disclosure of which is incorporated by reference herein in its entirety.

### TECHNICAL FIELD

The present disclosure relates to active-matrix digital displays with reduced communication bandwidth and reduced power requirements.

### BACKGROUND

Flat-panel displays are widely used to present images and information in graphic user interfaces controlled by computers. Such displays incorporate an array of light-controlling pixels disposed on a display substrate, backplane, or panel. Each pixel emits or reflects or otherwise controls light. Flat-panel displays can be passive-matrix (without pixel data storage on the display substrate and in each pixel) or active-matrix (with pixel data storage on the display substrate and in each pixel). Displays update the images or information presented (an image frame or single still image) at a frame rate, for example 60, 70, 120, 240, or 480 frames per second. At greater frame rates and for larger displays with greater resolution requiring more pixels and larger image frames, the communication bandwidth across the display backplane can limit the performance or size of the display because of wire conductivity limitations or parasitic capacitance or inductance on the backplane. Large high-resolution displays can have more pixels (requiring more pixel data), smaller wires (because of limited space on the backplane), and longer wires (because the display is spatially larger). For example, a 4 k (2 k by 4 k) pixel, two-and-a-half-meter-diagonal color display with an image frame rate of 120 frames per second must transfer data at more than 200 million bits per second into the display over distances of more than two meters.

There is a need, therefore, for displays and systems that reduce the bandwidth and power requirements for a digital display.

### SUMMARY

According to some embodiments of the present disclosure, among other embodiments, a digital display can comprise display pixels and a display controller. Each display pixel can comprise a light emitter and a pixel circuit operable to receive and store pixel values in a pixel memory and control the light emitter to emit light corresponding to the pixel values. A pixel value can be a value of an image pixel or multiple pixel values corresponding to each color of an image pixel having multiple colors. The display controller can be operable to send the pixel values to the display pixels. In embodiments, each of the pixel values is a multi-bit pixel value comprising a first bit and a second bit, and the display controller can be operable to send the first bit to all of the display pixels and then send the second bit to all of the display pixels (e.g., after all of the first bits are sent to all of the display pixels. Each of the display pixels can comprise a pixel memory having a first portion and a second portion and the pixel circuit can be operable to receive and store the first bit in the first portion and then receive and store the second bit in the second portion. The first bit and the second bit can be separate bits and the first location and the second location can be separate locations in the pixel memory. In embodiments, the contents of the pixel memory are displayed by the light emitter after the first bit is stored in the first portion and before the second bit is stored in the second portion. Thus, each of the display pixels can be operable to receive and store the first bit, then display the pixel value in the pixel memory, then receive and store the second bit, then display the pixel value in the memory

In some embodiments, the multi-bit pixel value can comprise multiple first bits and/or multiple second bits and the display controller can be operable to send the first bits to all of the display pixels, then display the pixel value in the pixel memory, and then send the second bits to all of the display pixels. The first bits can have a larger value (e.g., have a greater place value) and the second bits can have a smaller value (e.g., a smaller place value) in the multi-bit pixel value. More generally, in embodiments, the multi-bit pixel value can comprises M groups of n bits each and the display controller can be operable to separately send each of the n bits in one of the M groups to all of the display pixels before sending another of the n bits in a different group of the M groups to any of the display pixels.

In some embodiments, the first bit can have a larger value and the second bit can have a smaller value in the multi-bit pixel value. For example, the first bit can have a higher or larger place value in the multi-bit pixel value than the second bit.

Each of the display pixels can be an active-matrix pixel. Each of the display pixels can comprise light emitters that each emit light of a different color, the pixel value can be a multi-bit pixel value comprising a first bit (or first bits) and a second bit (or second bits) for each of the light emitters, and the pixel circuit can be operable to control each of the light emitters to emit light corresponding to bits of the pixel value corresponding to the light emitter.

According to embodiments of the present disclosure, a method of controlling a digital display can comprise, in order, (i) receiving an image with a display controller, the image comprising multi-bit pixel values each comprising a first bit and a second bit, (ii) sending the first bit to a display pixel with the display controller, the display pixel comprising a pixel memory, a light emitter, and a pixel circuit operable to receive the multi-bit pixel value, store the multi-bit pixel value in the pixel memory, and control the light emitter to emit light corresponding to the pixel value, (iii) receiving the first bit and storing the first bit in the pixel memory with the pixel circuit, (iv) controlling the light emitter to emit light corresponding to the pixel value in the pixel memory with the pixel circuit, (v) sending the second bit to the display pixel with the display controller, (vi) receiving the second bit and storing the second bit in the pixel memory with the pixel circuit, and (vii) controlling the light emitter to emit light corresponding to the pixel value in the pixel memory with the pixel circuit.

The pixel memory can have a first portion and a second portion and can be operable to receive and store the first bit in the first portion and then receive and store the second bit in the second portion, and can comprise storing the first bit in the first portion and then storing the second bit in the second portion. In embodiments, the image is a first image and methods according to the present disclosure can comprise repeating steps (i) to (vii) with a second image so that in step (iv) the pixel circuit controls the light emitter to emit light corresponding to a first bit (or first bits) from the second image and a second bit (or second bits) from the first image. Thus, in some embodiments, the multi-bit pixel value can comprise first bits and methods can comprise sending the first bits with the display controller and in some embodiments the multi-bit pixel value can comprise second bits and methods can comprise sending the second bits with the display controller.

In some embodiments of the present disclosure, the multi-bit pixel value comprises first bits and methods can comprise receiving the first bits and storing the first bits in the pixel memory with the pixel circuit. In some embodiments of the present disclosure, the multi-bit pixel value can comprise second bits and methods can comprise receiving the second bits and storing the second bits in the pixel memory with the pixel circuit. The pixel memory can have a first portion and a second portion and methods can comprise storing the first bit in the first portion and the second bit in the second portion.

According to embodiments of the present disclosure, the multi-bit pixel can comprise M groups of n bits each. Methods can comprise (i) separately sending the n bits in one of the M groups to all of the display pixels with the display controller, (ii) receiving the n bits and storing the n bits in the pixel memory with the pixel circuit, (iii) controlling the light emitter to emit light corresponding to the pixel value in the memory with the pixel circuit, and (iv) repeating steps (i), (ii), and (iii) with a different one of the M groups, for example until all of the bits in each of the M groups are sent. In embodiments, the bits of a first group M sent temporally first to all of the display pixels can have a highest place value in the multi-bit value and the bits of successive groups M sent after the first group have successively lower place values.

According to embodiments of the present disclosure, a digital multi-bit pixel (e.g., in a display) can comprise a light emitter and a pixel circuit operable to receive and store a multi-bit pixel value in a pixel memory and control the light emitter to emit light corresponding to the multi-bit pixel value. The multi-bit pixel value can comprise a first bit (or first bits) and a second bit (or second bits), and the pixel circuit can be operable to successively receive and store the first bit(s) in the pixel memory, cause display of (e.g., enable display of) the multi-bit pixel value (e.g., by or on the display), receive and store the second bit(s) in the pixel memory, and cause display of (e.g., enable display of) the multi-bit pixel value (e.g., by or on the display). Some embodiments can comprise an array of pixels (e.g., in a display). Each pixel can comprise a light emitter and a pixel circuit operable to receive and store multi-bit pixel values in a pixel memory and control the light emitter to emit light corresponding to the multi-bit pixel values. Each multi-bit pixel value can comprise a first bit (or first bits) and a second bit (or second bits), and the pixel circuit can be operable to successively receive and store the first bit in the pixel memory, display the multi-bit pixel value, receive and store the second bit in the pixel memory, and display the multi-bit pixel value.

According to embodiments of the present disclosure, a digital display can comprise display pixels and a display controller. Each of the display pixels can comprise a light emitter and a pixel circuit operable to receive and store pixel values in a pixel memory and control the light emitter to emit light corresponding to the pixel values. Each of the pixel values can be a multi-bit pixel value comprising M groups of n bits in each group, M>1 and n≥1. The display controller can be operable to send the pixel values to the display pixels and can be operable to, for each of the pixel values, successively send a group of the M groups in the pixel value to all of the display pixels, pause for the display of the group by the display pixels (e.g., by or on the display) (e.g., display the multi-bit pixel value), and for each different group M of n bits in the pixel value, sequentially repeat steps the first two steps until all M groups of n bits are sent.

According to embodiments of the present disclosure, a digital multi-bit pixel (e.g., for use in a display) can comprise a pixel comprising a light emitter and a pixel circuit operable to receive and store a multi-bit pixel value in a pixel memory and control the light emitter to emit light corresponding to the multi-bit pixel value. The multi-bit pixel value can comprise M groups of n bits in each group, M>1 and n≥1. The pixel circuit can be operable to receive and store the n bits of a group of the M groups in the pixel memory and display all of bits of the multi-bit pixel value, and successively (a) receive and store the n bits of different groups M of n bits in the pixel memory and (b) display the multi-bit pixel value.

According to embodiments of the present disclosure, a display can comprise a digital display and display controller for controlling the digital display. A method of controlling the display can comprise receiving a sequence of images with the display controller, each image comprising an array of image pixel values each comprising a multi-bit pixel value having n bits, analyzing the sequence of images to determine relatively variable image portions and relatively static image portions with the display controller, for each of the pixel values in the relatively variable image portions, sending fewer than all of the n bits of the corresponding pixel value to a corresponding display pixel of the display pixels with the display controller, for each of the pixel values in the relatively static image portions, sending all of the n bits of the pixel value to a corresponding display pixel of the display pixels with the display controller, and displaying the image with the display pixels. In some of the embodiments, all of the image pixels are in the relatively variable image portions and none of the image pixels are in the relatively static image portions (e.g., the image sequence is a pan) so that the image sequence is displayed at a lower resolution than the native resolution of the display until the image sequence becomes a relatively static image.

According to embodiments of the present disclosure, a display can comprise a digital display and a display controller for controlling the digital display. The display controller can be operable to receive a sequence of images with the display controller, each of the images comprising an array of image pixel values each comprising a multi-bit pixel value having n bits, analyze the sequence of images to determine relatively variable image portions and relatively static image portions with the display controller, for each of the pixel values (e.g., values of the image pixels) in the relatively variable image portions, send fewer than all of the n bits of the corresponding image pixel value to a corresponding display pixel of the display pixels in the digital display with the display controller, for each of the image pixels in the relatively static image portions, send all of the n bits of the image pixel value to a corresponding display pixel of the display pixels in the digital display with the display controller. The digital display can be operable to display the pixel values with the display pixels. In some embodiments, all of the image pixels are in the relatively variable image portions and none of the image pixels are in the relatively static portions (e.g., the image sequence is a pan).

According to embodiments of the present disclosure, a method of controlling a display can comprise receiving a sequence of images with a display controller, each image comprising an array of image pixel values each comprising a multi-bit pixel value having n bits, analyzing the sequence of images to determine relatively variable image portions and relatively static image portions with the display controller, for each of the pixel values of the image pixels in the relatively variable image portions, sending fewer than all of the n bits of the image pixel value to a corresponding display pixel of the display pixels with the display controller, for each image pixel in the relatively static image portions, sending all of the n bits of the pixel value (e.g., of the image pixels) to a corresponding display pixel with the display controller, and displaying the images with the display pixels.

According to embodiments of the present disclosure, a method of controlling a display can comprise receiving a sequence of images with a display controller, each of the images comprising an array of image pixel values each comprising a multi-bit pixel value having N bits, analyzing the images in the sequence of images to determine relatively variable images and relatively static images with the display controller, for each of the pixel values of the image pixels in the relatively variable images, sending fewer than all of the n bits of the corresponding pixel value to a corresponding display pixel of the display pixels with the display controller, for each of the pixel values of the image pixels in the relatively static images, sending all of the n bits of the corresponding pixel values to a corresponding display pixel of the display pixels with the display controller, and displaying the images with the display pixels.

According to embodiments of the present disclosure, a digital display can comprise display pixels and a display controller for controlling the display pixels. Each display pixel can comprise a light emitter and a pixel circuit operable to receive and store pixel values in a pixel memory and control the light emitter to emit light corresponding to the pixel values. Each image pixel value can be a multi-bit pixel value. The display controller can be operable to receive a sequence of images, each of the images in the sequence comprising an array of image pixel values each comprising a multi-bit pixel value having N bits, analyze the image sequence to determine relatively variable images and relatively static images, for each of the pixel values in the relatively variable images, sending fewer than all of the N bits of the corresponding pixel value to a corresponding display pixel of the display pixels, for each image pixel in the relatively static images, sending all of the n bits of the corresponding image pixel value to a corresponding display pixel, and displaying the images with the display pixels, e.g., under the control of the display controller.

Certain embodiments of the present disclosure provide a digital display requiring less energy to operate at higher frame rates with reduced bandwidth especially suitable for relatively high-contrast or relatively static image sequences.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a schematic diagram of a digital display with an inset of a digital active-matrix pixel according to illustrative embodiments of the present disclosure;

FIG. 2A illustrates a multi-bit digital pixel value having two bits organized into two groups with a mutually exclusive first bit and second bit according to illustrative embodiments of the present disclosure;

FIG. 2B illustrates a multi-bit digital pixel value having eight bits organized into two groups with mutually exclusive first bits and second bits according to illustrative embodiments of the present disclosure;

FIG. 2C illustrates a multi-bit digital pixel value having twelve bits organized into three groups having mutually exclusive first bits, second bits, and third bits according to illustrative embodiments of the present disclosure;

FIGS. 3A-3G successively illustrate the contents of a pixel memory storing multi-bit pixel values having two bits organized into two groups corresponding to FIG. 2A according to illustrative embodiments of the present disclosure;

FIGS. 4A-4G successively illustrate the contents of a pixel memory storing multi-bit pixel values having eight bits organized into two groups corresponding to FIG. 2B according to illustrative embodiments of the present disclosure;

FIGS. 5A-5J successively illustrate the contents of a pixel memory storing multi-bit pixel values having twelve bits organized into three groups corresponding to FIG. 2C according to illustrative embodiments of the present disclosure;

FIGS. 6A and 6B are schematic diagrams of digital active-matrix multi-bit pixels according to illustrative embodiments of the present disclosure; and

FIG. 7 is a flow diagram according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF CERTAIN EMBODIMENTS

Certain embodiments of the present disclosure provide energy-efficient systems and displays requiring less power to operate at higher frequencies and increased frame rates. The systems and displays can comprise a digital, active-matrix multi-bit display comprising one or more digital, active-matrix pixels that each display a corresponding pixel value in a digital image. Each digital, active-matrix pixel can comprise one or more light emitters, for example one or more light emitters such as inorganic micro-light-emitting diodes emitting different colors of light. A display can comprise an array of pixels. The digital, active-matrix display can save power by loading successive, e.g., sequential, different portions of a multi-bit pixel value into each pixel for each digital image in separate load steps.

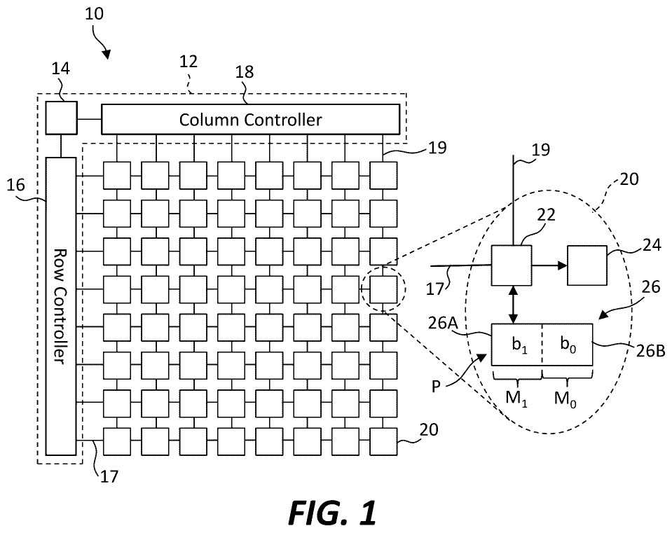

According to embodiments of the present disclosure and as illustrated in FIG. 1, a digital display 10 comprises display pixels 20 disposed on a display substrate, backplane, or panel. Each display pixel 20 can comprise a light emitter 24, a pixel memory 26, and a pixel circuit 22 operable to receive and store pixel values from a digital image into the corresponding pixel memory 26. Pixel circuit 22 can control light emitter 24 to emit light according to the stored pixel value. Each pixel value can be one or more multi-bit pixel values P comprising at least a first bit b and a second bit b (e.g., can be one or more digital binary values each having one or more bits b in each of two or more separate groups M such as M₀ and M₁ as shown in FIG. 1). Thus, pixel memory 26 can be large enough to store at least two separate bits b, for example a first bit b₁ of a first group M₁ in a first memory portion (logical location) 26A of pixel memory 26 and a second bit b₀ of a second group M₀ in a second memory portion (logical location) 26B of pixel memory 26. The first memory portion 26A and the second memory portion 26B can be different, separate, and independently accessible locations or storage elements in pixel memory 26. Digital display 10 can be a display comprising display pixels 20 spatially corresponding to pixels in an image (image pixels) that receives and stores digital pixel values (e.g., binary multi-bit pixel values P) and outputs light corresponding to the digital multi-bit pixel value P stored in the display pixel 20 at each display pixel 20 with a light emitter 24.

Display pixels 20 can comprise multiple light emitters 24, for example multiple color light emitters 24 that each emit a different color of light, for example a red light emitter 24 that emits red light, a green light emitter 24 that emits green light, and a blue light emitter 24 that emits blue light. In some embodiments comprising display pixels 20 comprising multiple light emitters 24, the pixel values include multiple digital multi-bit pixel values P, one for each of the multiple light emitters 24, for example three binary multi-bit digital values, each corresponding to a different color of light (e.g., red, green, and blue) emitted by light emitters 24 corresponding to the pixel value and pixel memory 26 has storage for each of the multi-bit pixel values P in the pixel value (not shown in FIG. 1).

In some embodiments of the present disclosure, a display controller 12 is operable to receive a digital image comprising pixel values and to transmit the pixel values in the digital image to corresponding display pixels 20. For example, each pixel value in the digital image can be sent to a different corresponding display pixel 20 so that each display pixel 20 can receive an individual and separate pixel value in the digital image having a location in the digital image corresponding to a spatial location of a display pixel 20 in an array of display pixels 20 on a display substrate. In some embodiments, the pixel values are each a single binary multi-bit pixel value P, for example corresponding to a desired amount of light emitted by a single light emitter 24 in a display pixel 20. In some embodiments, the pixel values are each multiple binary multi-bit pixel values P, for example corresponding to a desired amount of light for emission by multiple light emitters 24 in a display pixel 20 (e.g., red, green, and blue light emitters 24).

According to the present disclosure, in some embodiments, display controller 12 can be operable to first send (e.g., transmit or communicate) one or more first bit(s) b of each binary multi-bit pixel value P in a digital pixel value to each of display pixels 20 and then, after all of the first bit(s) b are sent to display pixels 20, second send one or more second bit(s) b of each binary multi-bit pixel value P in the pixel value to each of display pixels 20. Thus, all of bits b in the pixel values of a digital image are loaded into digital display 10 in two (or more) steps or frames. In the first step, all of first bit(s) b of each multi-bit pixel value P are loaded into display pixels 20 of digital display 10, then in a second step all of second bit(s) b of each multi-bit pixel value P are loaded into display pixels 20 of digital display 10. Thus, each of display pixels 20 can comprise a pixel memory 26 having a first portion 26A and a second portion 26B and pixel circuit 22 is operable to receive and store the first bit(s) b in first portion 26A and then receive and store the second bit(s) b in second portion 26B. The first bit(s) b and the second bit(s) b can be separate bits and first portion 26A can be a logical first storage location and second portion 26B can be a logical second location in pixel memory 26 and first and second portions 26A, 26B can be separate physical storage elements and logical storage locations or addresses in pixel memory 26.

As shown in FIG. 1, digital display 10 can comprise an array of display pixels 20 controlled by display controller 12. Each row of display pixels 20 in the array of display pixels 20 can be electrically connected to a separate and individual row wire 17 and each column of display pixels 20 in the array of display pixels 20 can be electrically connected to a separate and individual column wire 19. The rows of display pixels 20 can be controlled by a row controller 16 through row wires 17 and the columns of display pixels 20 can be controlled by a column controller 18 through column wires 19 under the direction of array controller 14 to provide matrix-address control to the array of display pixels 20. Display controller 12 can comprise array controller 14, row controller 16, and column controller 18. Array controller 14 can be operable to receive a digital image comprising pixel values spatially corresponding to display pixels 20 in an array of display pixels 20 from an external source such as a computer, communication, or imaging system. Each pixel value comprises a binary multi-bit pixel value P for each light emitter 24 in display pixel 20. Array controller 14 controls row controller 16 to select a row of display pixels 20 and controls column controller 18 to provide first bits b of the binary multi-bit pixel values P of pixel values in the digital image corresponding to the selected row. The provided first bits b are input by pixel circuits 22 of display pixels 20 in the selected row. Each row is successively selected to load all of first bit(s) b in the digital image into display pixels 20. The process then repeats for the second bit(s) b. Once all of first bit(s) b and second bit(s) b are loaded, the entire pixel value for each pixel in the digital image is loaded into digital display 10.

Array controller 14, row controller 16, and column controller 18 can each or together be one or more integrated circuits disposed on or integrated in a display substrate with display pixels 20 and connected to rows and columns of display pixels 20 with wires. Pixel circuits 22 and pixel memory 26 can each comprise one or more non-native semiconductor integrated circuits (e.g., silicon CMOS circuits) that can be, but are not necessarily, disposed on the display substrate using micro-transfer printing, and can each comprise a fractured or separated tether. Likewise, light emitters 24 can each be an unpackaged bare die of a semiconductor integrated circuit (e.g., a compound semiconductor device) that can be, but is not necessarily, disposed on the display substrate using micro-transfer printing, and can each comprise a fractured or separated tether. In some embodiments, pixel circuits 22 are native to and formed in or on the display substrate, for example using lithography. Light emitters 24 can be inorganic light emitting diodes, for example micro-light-emitting diodes having a length or width no greater than two hundred, one hundred, fifty, twenty, fifteen, twelve, ten, seven, five, three, two, or one microns, and a thickness no greater than fifty, twenty, fifteen, twelve, ten, seven, five, three, two, or one microns. A display substrate can comprise any useful substrate, for example glass, plastic, or a semiconductor, on which integrated circuits can be disposed (e.g., by micro-transfer printing) or formed and electrically or optically connected, e.g., using photolithographic methods and materials.

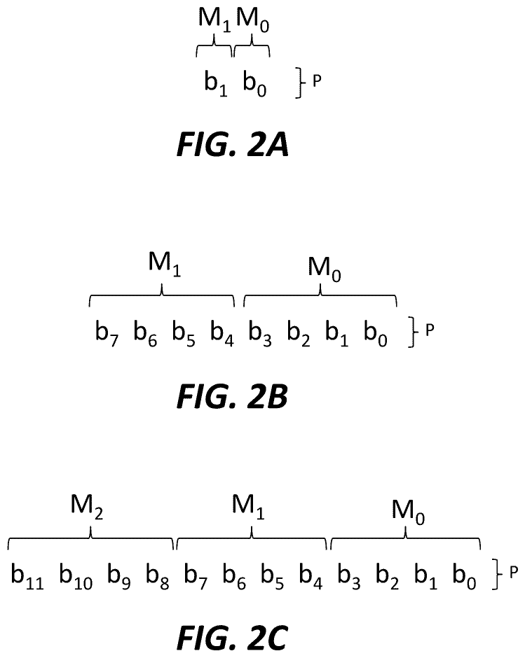

FIGS. 2A-2C illustrate embodiments of multi-bit pixel values P each comprising a single digital binary pixel value. FIG. 2A illustrates a two-bit, multi-bit pixel value P having a single first bit b₁ and a single second bit b₀. Bits b₁ and b₀ comprise a single two-bit binary number. As is customary, N bits in a single binary value have a place value of 2P that increases as the bits b are written from right to left in places p, where the right-most bit is bit zero (b₀ for place p=0) and the left-most bit is bit (N−1) (b_{N-1} for place p=N−1) where p is the bit place ranging from zero to N−1. The relative value 2^{P} of a bit b in the sequence from right to left is the place p of the bit b so that the value of bits b vary from place p=zero (equal to 2⁰ or one) to place p=(N−1) (equal to 2^{N-1}). In the two-bit example of FIG. 2A where N=2, bit b₀ of place p=0 has a place value equal to 2⁰ or one and bit b₁ of place p=1 has a place value equal to 2¹ or two. Thus, the place value p of bits b increases by a factor of two as written from right to left so that bits b (e.g., bit b¹) to the left of other bits (e.g., bit b⁰) represent a greater value in multi-bit pixel value P. As used herein, a subscripted M refers to a group of n (lowercase) bits b in the group M and N (uppercase) refers to the total number of bits b in multi-bit pixel value P. Thus, group M has n bits, N=M×n, and n=N/M (assuming M is a factor of N so that M divides N divides evenly and n is the same for every group M of bits b).

In embodiments, each multi-bit pixel value P can comprise M groups of n bits each. As shown in FIG. 2A, N=2, n=1, and M=2 so that multi-bit pixel value P comprises two groups M of one bit each (bits b₀ and b₁), and a digital value range from zero (where b₁ equals zero and b₀ equals zero) to three (where b₁ equals two and b₀ equals one). FIG. 2B illustrates a single multi-bit digital pixel value having eight bits so N=8, M=2, and n=4. The eight bits are divided into two groups each labeled M with increasing subscripts from right to left corresponding to the relative place value of bits b in the group, ranging from M₀ to M₁ in the examples of FIGS. 2A and 2B. Bits b₀ to b₃ are second bits b in group M₀ and bits b₄ to b₇ are first bits b in group M₁ so first bits b comprise four bits and second bits b comprise four bits, so that M=2 and n=4.

FIG. 2C illustrates a single multi-bit digital pixel value having twelve bits divided into three groups so N=12, M=3, and n=4. Bits b₀ to b₃ are third bits b, bits b₄ to b₇ are second bits b, and bits b₈ to b₁₁ are first bits b so first bits b comprise four bits, second bits b comprise four bits, and third bits b comprise four bits. Although these exemplary embodiments have equal numbers N of bits b in each group M, in some embodiments the number of bits in different groups can be different, for example if M=3 and N=8 (eight not integrally divisible by three). In embodiments, the first bit (or bits) b can have a larger place value p than the second bit (or bits) b and the second bit(s) b can have a smaller place value than first bit(s) b in multi-bit pixel value P.

In embodiments, display controller 12 is operable to separately send each of the n bits in one of the M groups to all of display pixels 20 before sending the n bits in a different group of the M groups to any of display pixels 20. In embodiments, the n bits in a group M having a greater place value (e.g., the first bits) are sent before the n bits in a group M having a smaller place value (e.g., the second bits).

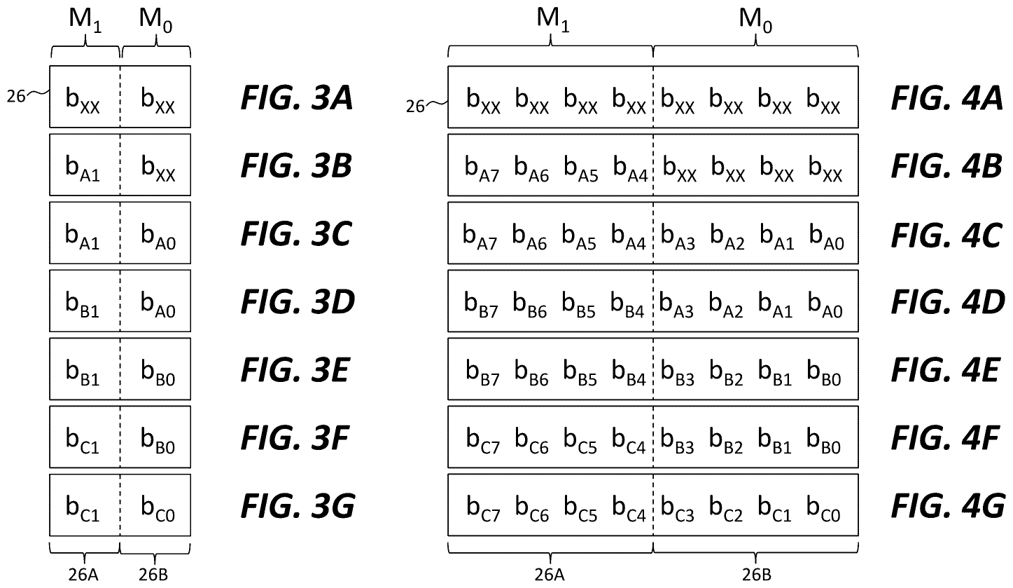

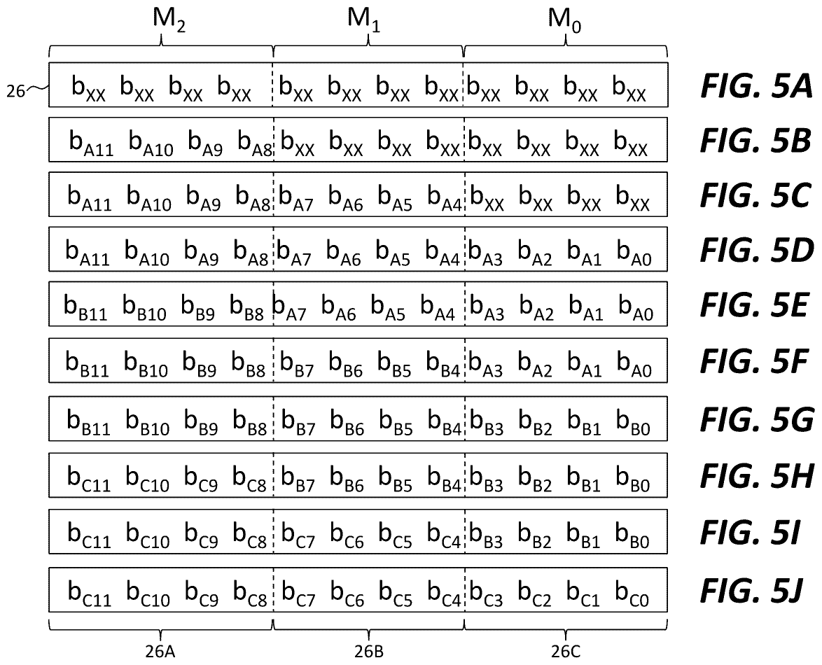

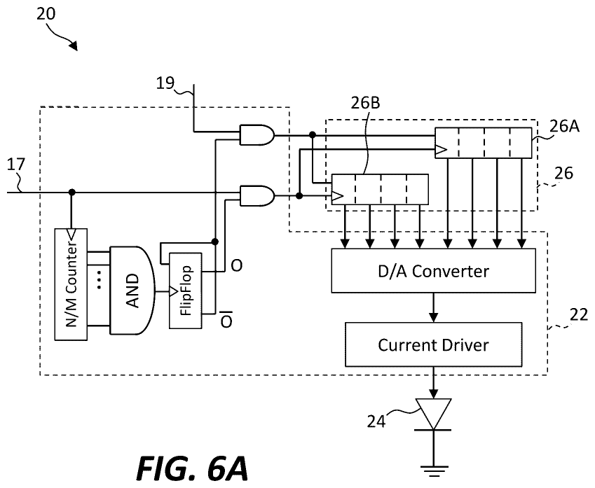

FIGS. 3A-3G, 4A-4G, and 5A-5J represent the process of loading the M groups of n bits each of multi-bit pixel value P into pixel memory 26 having storage locations or elements for each of the M times n bits b and for each of successive images A, B, and C (and can be repeated for further successive images). The illustrations of FIGS. 3A-3G correspond to the example of FIG. 2A, the illustrations of FIGS. 4A-4G correspond to the example of FIG. 2B, and the illustrations of FIGS. 5A-5J correspond to the example of FIG. 2C.

As shown in FIG. 3A, in an initial state the contents of the two-bit pixel memory 26 are unknown (represented by X) or can be cleared to a predetermined known state such as zero. In a first step and as shown in FIG. 3B, the first bit b of a first image A (b_{A1}) is loaded into the higher-place-value storage location M₁ of pixel memory 26, leaving the lower-place-value storage location M₀ unchanged. The entire contents of pixel memory 26 (both bits) can then be displayed but the displayed image will have pixel values whose lower-place bit bao are undefined (or zero) and can therefore be partially unrepresentative of (inaccurately represent) the pixels in image A. In a next step and as shown in FIG. 3C, the second bit b of the first image A (b_{A0}) is loaded into the lower-place-value storage location M₀ of pixel memory 26, leaving the higher-place-value storage location M₁ unchanged and equal to B_{A1}. The contents of pixel memory 26 can then be displayed and the displayed image will have pixel values accurately representative of the image A pixels.

In a next step as shown in FIG. 3D, the first bit b₁ of a second image B (b_{B1}) is loaded into the higher-place-value storage location M₁ of pixel memory 26, leaving the lower-place-value storage location M₀ with second bit bao unchanged. The contents of pixel memory 26 can then be displayed but the displayed image will have pixel values whose upper-place first bits b are representative of pixels in image B and whose lower-place second bits b stored in M₀ are representative of pixels in image A and can therefore be partially unrepresentative of the image B pixels. In a next step and as shown in FIG. 3E, the second bit b of the second image B (b_{B0}) is loaded into the lower-place-value storage location M₀ of pixel memory 26, leaving the higher-place-value storage location M₁ unchanged with image B first bit b_{B1}. The contents of pixel memory 26 can then be displayed and the displayed image will have pixel values accurately representative of the image B pixels. The process can then repeat with the first bit b in M₁ of image C as shown in FIG. 3F and second bit b in M₀ of image C and can continue with successive images.

As shown in FIG. 4A, in an initial state the contents of the eight-bit pixel memory 26 are unknown (represented by X) or can be cleared to a known state such as zero. In a first step and as shown in FIG. 4B, the first four bits b of a first image A (b_{A4} to b_{A7}) are loaded into the higher-place-value storage location M₁ of pixel memory 26, leaving the contents of lower-place-value storage location M₀ unchanged. The contents of pixel memory 26 (all eight bits) can then be displayed but the displayed image will have pixel values whose upper-place first bits b are representative of pixels in image A and whose lower-place bits bao to b_{A3} are undefined (or zero) and can therefore be partially unrepresentative of (inaccurately represent) the image A pixels. In a next step as shown in FIG. 4C, the second four bits b of the first image A (b_{A3} to b_{A0}) are loaded into the lower-place-value storage location M₀ of pixel memory 26, leaving the higher-place-value storage location M₁ with bits b_{A4} to b_{A7} unchanged. The contents of pixel memory 26 can then be displayed and the displayed image will have pixel values representative of the image A pixels, since pixel memories 26 of display pixels 20 store the entire multi-bit pixel values P of each pixel in image A.

In a next step and as shown in FIG. 4D, the first four bits b_{B4} to b_{B7} of a second image B are loaded into the higher-place-value storage location M₁ of pixel memory 26, leaving the lower-place-value storage location M₀ with second bits bao to b_{A3} unchanged. The contents of pixel memory 26 can then be displayed but the displayed image will have pixel values whose upper-place first bits b stored in M₁ are representative of pixels in image B and whose lower-place second bits stored in M₀ are representative of pixels in image A and can therefore be partially unrepresentative of the image B pixels. In a next step as shown in FIG. 4E, the second bits b of the second image B (b_{B3} to b_{B0}) are loaded into the lower-place-value storage location M₀ of pixel memory 26, leaving the higher-place-value storage location M₁ unchanged with image B first bits b_{B7} to b_{B4}. The contents of pixel memory 26 can then be displayed and the displayed image will have pixel values representative of the image B pixels, since pixel memories 26 of display pixels 20 store the entire multi-bit pixel values P of each pixel in image B. The process can then repeat with the first bits b_{C4} to b_{C7} of image C in M₁ as shown in FIG. 4F and second bits b_{C0} to b_{C3} of image C in M₀ as shown in FIG. 4G and can continue with successive images.

As shown in FIG. 5A, in an initial state the contents of the twelve-bit pixel memory 26 are unknown (represented by X) or can be cleared to a known state such as zero. In a first step and as shown in FIG. 5B, the first four bits b of a first image A (b_{A8} to b_{A11}) are loaded into the highest-place-value storage location M₂ of pixel memory 26, leaving the contents of lower-place-value storage locations M₁ and M₀ unchanged. The contents of pixel memory 26 (all twelve bits) can then be displayed but the displayed image will have pixel values whose lower-place bits b_{A0} to b_{A7} in M₀ and M₁ are undefined (or zero) and can therefore be partially unrepresentative of (inaccurately represent) the image A pixels. In a next step and as shown in FIG. 5C, the second four bits b of the first image A (b_{A7} to b_{A4}) are loaded into the middle-place-value storage location M₁ of pixel memory 26, leaving the highest-place-value storage location M₂ with bits b_{A8} to b_{A11} and lowest-place-value storage location M₀ with bits b_{A0} to b_{A3} unchanged. The contents of pixel memory 26 can then be displayed and the displayed image will have pixel values more but not completely representative of the image A pixels. In a next step and as shown in FIG. 5D, the third four bits b of the first image A (b_{A3} to b_{A0}) are loaded into the lowest-place-value storage location M₀ of pixel memory 26, leaving the higher-place-value storage locations M₂ and M₁ with bits b_{A4} to b_{A11} unchanged. The contents of pixel memory 26 can then be displayed and the displayed image will have pixel values completely representative of the image A pixels, since pixel memories 26 of display pixels 20 store the entire multi-bit pixel values P of each pixel in image A.

In a next step and as shown in FIG. 5E, the first four bits b_{B8} to b_{B11} of a second image B are loaded into the highest-place-value storage location M₂ of pixel memory 26, leaving the lower-place-value storage locations M₁ and M₀ with second and third bits bao to b_{A7} unchanged. The contents of pixel memory 26 can then be displayed but the displayed image will have pixel values whose lower-place second and third bits b_{A7} to bao stored in M₁ and M₀ are representative of pixels in image A and can therefore be partially unrepresentative of the image B pixels. In a next step and as shown in FIG. 5F, second bits b of the second image B (b_{B7} to b_{B4}) are loaded into the middle-place-value storage location M₁ of pixel memory 26, leaving the highest-place-value storage location M₂ and lowest-place storage location M₀ unchanged with image B first bits b_{B11} to b_{B8} and third bits b_{B3} to b_{B0}. The contents of pixel memory 26 can then be displayed and the displayed image will have pixel values partially but more representative of the image B pixels. In a next step and as shown in FIG. 5G, third bits b of the second image B (b_{B3} to b_{B0}) are loaded into the lowest-place-value storage location M₀ of pixel memory 26, leaving the higher-place-value storage locations M₂ and M₁ with image B first bits b_{B11} to b_{B8} and second bits b_{B7} to b_{B4}. The contents of pixel memory 26 can then be displayed and the displayed image will have pixel values fully representative of the image B pixels, since pixel memories 26 of display pixels 20 store the entire multi-bit pixel values P of each pixel in image B.

The process can then repeat with the first bits b_{C11} to B_{C8} of image C in M₂ as shown in FIG. 5H, second bits b_{C7} to B_{C4} of image C in M₁ as shown in FIG. 5I, and third bits b_{C3} to B_{C0} of image C in M₀ as shown in FIG. 5J and can continue with successive images.

In general, pixel memory 26 can comprise M sets of portions (logical locations) of n bits each, where multi-bit pixel value P has M×n bits. If digital display 10 is a color display, pixel memory 26 can comprise M sets of locations of n bits each for each of the colors and the process described in FIGS. 3A-3G, 4A-4G, and 5A-5J (or an equivalent for the M sets of locations of n bits each) for each color, simultaneously. For example, the pixel value for a three-color display with eight bits per color has twenty four bits. With M=2 sets, each pixel memory 26 can store twelve bits organized into three groups M (one for each color) of four bits each. FIG. 2B and FIGS. 4A-4G illustrate multi-bit pixel values P for two groups M for one of the three colors.

Circuits used to control pixels in a display can have a limited frequency capability, for example a minimum switching period or maximum switching frequency that defines the shortest controllable temporal pulse received or provided by the pixel control circuits. The greater the frequency (and the shorter the frame time), the more difficult it is to transfer large amounts of data over large substrates. In embodiments of the present disclosure, each of the illustrations of FIGS. 3A-G, 4A-4G, or 5A-5J correspond to a frame and the amount of data transferred in each frame for each display pixel 20 is N/M rather than N, as would be the case for a conventional design. Therefore, the difficulty of loading bits into digital display 10 is reduced by a factor of M, for example enabling a reduction in power use by up to a factor of M, an increase in resolution or size by up to a factor of M, an increase in frame rate by up to a factor of M, or a combination thereof.

In embodiments of the present disclosure, M frames are required to completely load an image (e.g., images A, B, C in FIGS. 3A-5J) into display pixels 20 of digital display 10. Therefore, the image displayed by display pixels 20 is initially inaccurate and becomes more accurate as the M frames are successively loaded. By first loading first bits b, then second bits b, then third bits b, and so forth (if present), the bits b of a multi-bit pixel value P having the greater place value are loaded first, so that the partially loaded image is displayed more accurately, followed by the bits corresponding to successively lower place values. Thus, over the successive M frames, a viewer of digital display 10 can perceive an image that may be initially inaccurate but becomes successively more accurate over time and with successive frames. Thus, images can appear blurrier but successively sharper as the successive frames are displayed. The visual effect can be lessened (e.g., to the point of being not noticeable) at higher frame rates while preserving the benefits of reduced bit loading difficulty discussed previously.

Embodiments of the present disclosure can be particularly useful where successive images have a high contrast (e.g., are largely binary or black-and-white) so that display pixels 20 tend to output image values that are all on or all off. In such embodiments, the successive approximations of the display images when changing a pixel from white to black will first display an intermediate gray color in the pixel. Likewise, when changing a pixel from black to white display pixels 20 will first display an intermediate gray color in the display pixel 20. This intermediate gray pixel color will not be obtrusive to a viewer because it is not a different color and will most often (but not always) have a display pixel 20 value that is between the pixel values of the initial image (e.g., image A) and a successive image (e.g., image B) and can therefore be acceptable, or even unnoticeable, to a human viewer.

Embodiments of the present disclosure can also be particularly useful where successive images are relatively static (e.g., largely stay the same and change only infrequently) so that display pixels 20 tend to output successive image values that are the same. In such embodiments, the successive approximations of the display images are actually correct, because each successive display pixel 20 value is the same as the prior display pixel 20 value. Such relatively constant images are often found when using a computer and display for composing and editing text (e.g., with a word processing or email software application), composing and editing drawings (e.g., with a drawing software application), composing and editing spreadsheets (e.g., with a spreadsheet software application), and displaying relatively static content for reading, whether commercially (e.g., menus, advertisements, billboards, informational screens) or personally (e.g., book pages). These applications are very frequently used on computers used for work (as opposed to entertainment which often employs more-rapidly changing video sequences of images). Consequently, embodiments of the present disclosure are usefully applied to displays used to support such tasks to save energy, especially for portable displays where available power can be limited. In some embodiments, digital display 10 systems have at least two operating modes. In a first mode, power is saved by using embodiments of the present disclosure for the tasks listed above and, in a second mode, a conventional single-frame image-loading process is used to support video applications with rapidly changing multi-bit pixel color or gray-scale images.

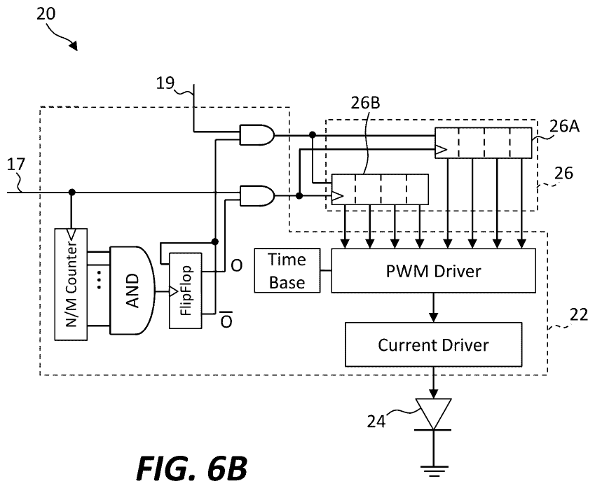

Display pixels 20 useful in applications of the present disclosure can be designed in many ways, as will be appreciated by those knowledgeable in the electronic and display arts. FIGS. 6A and 6B show two illustrative embodiments. As shown in FIGS. 6A and 6B, display pixel 20 comprises a pixel circuit 22 operable to receive control signals (e.g., provided by display controller 12 comprising array controller 14, row controller 16, and column controller 18 on row wires 17 and column wires 19, as also shown in FIG. 1). Pixel circuit 22 interacts with pixel memory 26 and light emitter 24, as also shown and described with respect to FIG. 1. Light emitter 24 can be a light-emitting diode (e.g., a micro-transfer printed micro-LED). Pixel memory 26 can comprise a separately accessible portion for each group M of bits b. As shown in FIGS. 6A and 6B, pixel memory 26 comprises two portions 26A, 26B corresponding to two groups M (M=2) of four bits each (n=4) in an eight-bit (N=8) multi-bit pixel value P as shown in the examples FIGS. 2B and 4A-4G. Pixel memory 26 can comprise any useful digital storage device, including SRAM, DRAM, flipflops, and registers, for example a shift register, and can comprise one or more circuits or integrated circuits (for example comprising silicon CMOS circuits). Pixel circuit 22 can comprise one or more electrically connected integrated circuits (for example comprising silicon CMOS circuits) that are electrically connected to pixel memory 26 and light emitter 24.

Pixel circuit 22 can receive multi-bit data on column wire 19 and selection signals on row wire 17. Row wire 17 can also transmit a clock signal in concert with bits sequentially provided on column wire 19 corresponding to serially transmitted bits of the multi-bit data. In some embodiments, a counter (or other mechanism for distinguishing between first bit(s) b and second bit(s) b in different groups M) counts the number of bit(s) b until a group M of bit(s) b is received (e.g., the counter counts to N/M). When the bit(s) b in a group M are received and counted a state machine (e.g., a flipflop or latch) can toggle from one state to another state in response to the count indicated with an AND gate, indicating the group M of n bits received. The state is used to enable data input (e.g., pixel value bits) to a corresponding portion (e.g., first portion 26A or second portion 26B) of pixel memory 26.

FIGS. 6A and 6B illustrate the use of two serial shift registers with parallel outputs for each group M of n bits for pixel memory 26 (in this example two groups M of four bits each of an eight-bit multi-bit value corresponding to FIG. 2B and FIGS. 4A-4G requiring a two-bit counter) to implement pixel memory 26. Some other embodiments can comprise three or more groups M and a greater (or smaller) number of bits N/M in each group M (e.g., corresponding to embodiments such as is illustrated in FIGS. 5A-5J). Bits b stored in the M portions (locations) of pixel memory 26 can be output together, e.g., through a digital-to-analog converter controlling a current source that drives the light emitter 24, for example a micro-light-emitting diode, as shown in FIG. 6A. FIG. 6B illustrates the use of a pulse-width modulator (PWM) and time base to drive light emitter 24 at a single current for variable amounts of time within an image frame and thereby display the pixel data. Counters, AND gates, flipflops or other state machines, digital-to-analog converters, and current drivers are all known in the art and various designs for such functions can be used in various embodiments of the present disclosure. The design of FIGS. 6A and 6B are merely illustrative and provided for understanding.

The integrated circuits in display pixel 20 can be thin-film circuits disposed and patterned on a display substrate or separate integrated circuits (for example unpackaged bare die having substrates separate from the display substrate) disposed on the display substrate, for example by micro-transfer printing and can comprise fractured or separated tethers.

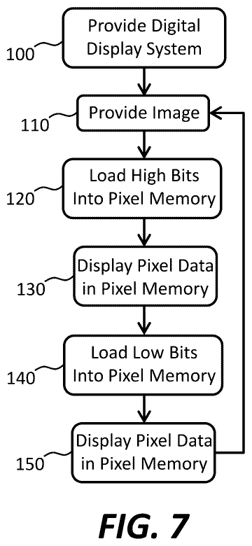

FIG. 7 is a flow diagram illustrating methods of the present disclosure, including those shown in FIGS. 3A-3G, 4A-4G, and 5A-5J. As shown in FIG. 7, a digital display 10 is provided in a first step 100. An image is provided from an external source (e.g., a computer or image communication system) in step 110, for example to a display controller 12. The image can comprise image pixels, each image pixel spatially corresponding to a display pixel 20 in digital display 10 and comprising a digital binary multi-bit pixel value P, for example corresponding to a desired light output from a light emitter 24 comprised in display pixel 20. Multi-bit pixel value P can be divided into groups M of bit(s) b. At least one group M of bit(s) b are first bit(s) and another group M of bit(s) b are second bit(s).

In step 120, the first bit(s) of each multi-bit pixel value P are loaded into a first portion (logical location) of pixel memory 26 of a corresponding display pixel 20, for example using matrix addressing controlled by row controller 16 to select rows of display pixels 20 using row wires 17 and column controller 18 using column wires 19 to provide rows of pixel values to successive rows of display pixels 20. Optionally, pixel memory 26 is cleared (e.g., set to a zero value corresponding to no light output by light emitter 24) before the first bit(s) are loaded in step 120. The first bit(s) can have a greater place value p in multi-bit pixel value P (e.g., are high bits) than the second bit(s) (e.g., that are low bits). In step 130, the contents of pixel memory 26 are output and displayed by light emitter 24. Because first bit(s) b have a greater place value than second bit(s) b, the image displayed in step 130 will be more accurate (will more accurately or more completely represent the image) than if first bit(s) b had a smaller place value than second bit(s) b.

In step 140, the second bit(s) of each multi-bit pixel value P are loaded into a second portion (logical location) of pixel memory 26 different from the first portion (logical location) of each corresponding display pixel 20 and the contents of pixel memory 26 are displayed in step 150. If M equals two (e.g., multi-bit pixel value P has only first bit(s) and second bit(s)), the image displayed will be correct and light emitted by light emitter 24 will correspond to the value of the entire multi-bit pixel value P.

If M is greater than two (e.g., multi-bit pixel value P has third bit(s)—as in FIGS. 2C, 5A-5J—or more and pixel memory 26 has a third portion 26C or more), steps 140 and 150 are sequentially and successively repeated for each group of M pixels with successively smaller place values p (ever lower-place bit groups M) until all of groups M of bit(s) b are stored in pixel memory 26 and finally displayed as a completely accurate representation of the provided image. The process can then repeat by providing, loading, and display first and second bit(s) b of another image in steps 110-150.

In embodiments, when displaying successive images in digital display 10, each image (e.g., a temporally second image B) will initially be displayed with high-place-value bits b corresponding to the image and low-place value bits b corresponding to the previous image (e.g., a temporally first image A). Thus, embodiments of the present disclosure comprising a sequence of images comprising a temporally first image and a temporally subsequent second image can comprise displaying the high-place value bits of multi-bit pixel values P of the second image and the low-place value bits of multi-bit pixel values P of the first image at a same time as a single image combining both first and second images. At some times, therefore, multi-bit pixel value P stored in pixel memory 26 comprises high-place-value bits from one image later in a sequence of images and low-place-value bits from another image, earlier in the sequence of images.

In some embodiments of the present disclosure, a display pixel 20 in a digital display 10 can comprise display pixels 20, e.g., arranged in an array of rows and columns on a display substrate or backplane. Each display pixel 20 can comprise a light emitter 24 and a pixel circuit 22 operable to receive and store pixel values in a pixel memory 26 and control the light emitter 24 to emit light corresponding to the pixel values. Each pixel value can be a multi-bit pixel value P comprising a first bit b (or first bits b) and a second bit b (or second bits b) and pixel circuit 22 can be operable to successively receive and store first bit(s) b in a first storage location or element in pixel memory 26, display the pixel value, receive and store second bit(s) b in a second storage location or element in pixel memory 26, and display the pixel value. The first storage portion, location, or element can be different and separately accessible from the second storage portion, location, or element in pixel memory 26.

Displaying an image stored in pixel memory 26 when only the higher-place-value first bit(s) b of the image are stored in first locations of pixel memory 26 (e.g., in step 130) can result in an inaccurate or somewhat unrepresentative image display that is then corrected when the lower-place-value second bit(s) b of the image are stored in second locations of pixel memory 26 and displayed (e.g., in step 150). However, if successive images are high-contrast images or are relatively static and unchanging, the inaccuracy can be limited or imperceptible to a viewer of digital display 10. Thus, embodiments of the present disclosure can apply the method of FIG. 7 when images are determined or selected to be high-contrast or relatively static images to save power in digital display 10, for example in office or internet search and review applications, and can use a conventional method of loading all of the bits of each pixel in each frame when the provided images are not high-contrast or relatively static images, e.g., have a greater gray-scale content or are more continuously variable (e.g., as in filmed image sequences). Moreover, embodiments of the present disclosure can be applied to successive images having a relatively high frame rate, for example no less than 100, 120, 240, 480, 960, or 1920 frames per second. Embodiments of the present disclosure can reduce the bandwidth and power requirement for a digital display 10, e.g., a backplane or substrate for a display. This is especially useful for battery-operated displays with limited power.

In some embodiments, entire images can be selected to operate with multi-bit pixel values having first and second bits loaded into a display with different image frames. In some embodiments, portions of an image can be selected to operate with multi-bit pixel values having first and second bits loaded into a display with different image frames. For example, a first portion of an image can be loaded conventionally with all of the bits associated with each pixel value loaded into the display and a second portion of the image different from the first portion can be loaded into the display with multi-bit pixel values having first and second bits loaded into the display with different image frames. The first portion image portion and the second image portion can be distinguished by analyzing the image (e.g., with display controller 12) to distinguish different attributes of the first and second image portions. In some embodiments, the first image portion is relatively low-contrast and the second image portion is relatively high-contrast. In some embodiments, the first image portion is relatively variable (e.g., high-motion image portions having image content that changes relatively frequently or rapidly) and the second image portion is relatively static (e.g., low-motion image portions having image content that changes relatively infrequently). Even if only some portions of an image use multi-bit pixel values having first and second bits loaded into the display with different image frames, some reduction in bandwidth can be achieved, depending on the relative sizes of the first and second image portions. In some embodiments, an entire frame can be loaded with fewer than of the bits in the multi-bit value for each display pixel, for example if the frame is part of a sequence of images showing relatively variable pixel content at every pixel in the image. Since the human visual system cannot readily perceive high fidelity pixels with many bits if the pixel value (image content) is rapidly changing, such reduced-information pixel content can reduce bandwidth needs without any impact on perceived image quality. In some such applications, the second bit(s) b are never loaded or displayed at all so that only a rapidly changing low-fidelity (low bit count) image is displayed. Where image content (or entire images) is relatively static, all of the bits in each multi-bit pixel value P can be displayed for each frame.

Backplane bandwidth limitations restrict the amount of data that can be loaded or distributed into an array of display pixels 20 in a display. This limits the maximum frame rate (the minimum frame period) for a display comprising an array of such display pixels 20. Thus, there is an inherent limit to the image frame rate and gray-scale resolution that can be supported by a pixel circuit 22 defined by the hardware implementation of the display pixel 20 and digital display 10. For example, the bandwidth can be limited by the slew rate of an electronic input or output signal, control signal, or driving transistor, by the parasitic resistance, capacitance, or inductance of control signal wires or driving wires, by the pixel circuit's ability to drive or respond to a desired amount of current at a given voltage, or by the pixel circuit's ability to drive or respond to a desired voltage at a given current.

The electronic circuits available in some displays can have relatively large and slow transistors (e.g., in thin-film transistor circuits coated on a display substrate). More complex circuits and faster-switching materials can operate at higher frequencies and provide more power at higher voltages but can be more expensive or impractical for a given display. There is, therefore, a need for pixel circuits 22, in particular digital pixel-control circuits 22, that can provide improvements in frame rate and display resolution without requiring expensive and complex control circuits or backplane implementations or increased power. Embodiments of the present disclosure provide digital displays 10 with reduced bandwidth and power requirements and that do not necessarily require any image analysis or processing, as might be required, for example in an update-on-demand display system. Moreover, embodiments of the present disclosure are compatible with such alternative image update systems.

According to some embodiments of the present disclosure, light emitters 24 are micro-inorganic-light-emitting diodes (micro-iLEDs) with at least one of a width and a length that is no greater than 500 microns (e.g., no greater than 200 microns, no greater than 100 microns, no greater than 50 microns, no greater than 25 microns, no greater than 15 microns, no greater than 12 microns, no greater than 8 microns, or no greater than 5 microns). Micro-LEDs provide an advantage according to some embodiments of the present disclosure since they are sufficiently small and can be disposed spatially close together so that display resolution can be increased and embodiments of the present disclosure can mitigate the increased bandwidth needs of such high-resolution or large displays. Embodiments of the present disclosure can be constructed using micro-transfer printing. As used herein, a light emitter 24 can be a reflective light emitter 24 or an emissive light emitter 24 and digital display 10 can be an emissive display or a reflective display.

Methods of forming useful micro-transfer printable structures are described, for example, in the paper AMOLED Displays using Transfer-Printed Integrated Circuits, Journal of the SID, 19(4), 2012, and U.S. Pat. No. 8,889,485. For a discussion of micro-transfer printing techniques see, U.S. Pat. Nos. 8,722,458, 7,622,367 and 8,506,867, the disclosures of which are hereby incorporated by reference in their entirety. Micro-transfer printing using compound micro-assembly structures and methods can also be used with the present disclosure, for example, as described in U.S. patent application Ser. No. 18/432,677, filed Feb. 6, 2024, entitled Compound Micro-Assembly Strategies and Devices, the disclosure of which is hereby incorporated by reference in its entirety. In some embodiments, display pixels 20 are compound micro-assembled devices.

As is understood by those skilled in the art, the terms “over” and “under”, “above” and “below”, and “top” and “bottom” are relative terms and can be interchanged in reference to different orientations of the layers, elements, and substrates included in the present invention. For example, a first layer on a second layer, in some implementations means a first layer directly on and in contact with a second layer. In other implementations a first layer on a second layer includes a first layer and a second layer with another layer therebetween.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously.

Having expressly described certain embodiments, it will now become apparent to one skilled in the art that other embodiments incorporating the concepts of the disclosure may be used. Therefore, the claimed invention should not be limited to the described embodiments, but rather should be limited only by the spirit and scope of the following claims.

### PARTS LIST

b bit
M groups of n bits b
N number of bits b in a multi-bit pixel value
P multi-bit pixel value
10 digital display
12 display controller
14 array controller
16 row controller
17 row wire
18 column controller
19 column wire
20 display pixel
22 pixel circuit
24 light emitter
26 pixel memory
26A first portion/first logical location
26B second portion/second logical location
26C third portion/third logical location
100 provide digital display step
110 provide image step
120 load high bits into pixel memory step
130 display pixel data in pixel memory step
140 load low bits into pixel memory step
150 display pixel data in pixel memory step

1. A digital display, comprising:
a plurality of display pixels, each display pixel comprising a light emitter and a pixel circuit configured to receive and store pixel values and control the light emitter to emit light corresponding to the pixel values; and
a display controller configured to send the one or more pixel values to the display pixels,
wherein the pixel values comprise a multi-bit pixel value including a first bit and a second bit, and
wherein the display controller is configured to send the first bit to all of the plurality of display pixels and then to subsequently send the second bit to all of the plurality of display pixels.

2. The digital display of claim 1, wherein each of the plurality of display pixels comprises a pixel memory having a first memory location and a second memory location and the pixel circuit is configured to store the first bit in the first memory location and store the second bit in the second memory location.

3. The digital display of claim 2, wherein the first bit and the second bit are separate bits and the first memory location and the second memory location are separate locations in the pixel memory.

4. The digital display of claim 2, wherein the pixel circuit of each of the plurality of display pixels is configured to in order:
receive and store the first bit in the first memory location,
control the light emitter to emit light according to the pixel values stored in the pixel memory,
receive and store the second bit in the second memory location, and
control the light emitter to emit light according to the pixel values stored in the pixel memory.

5. The digital display of claim 1, wherein the first bit has a larger value and the second bit has a smaller value in the multi-bit pixel value.

6. The digital display of claim 1, wherein each of the plurality of display pixels is an active-matrix pixel.

7. The digital display of claim 1, wherein the multi-bit pixel value comprises first bits and second bits and the display controller is configured to send the first bits to all of the plurality of display pixels and then to subsequently send the second bits to all of the plurality of display pixels.

8. (canceled)

9. The digital display of claim 1, wherein each of the plurality of display pixels comprises a plurality of light emitters that each emit light of a different color, the pixel values comprise a multi-bit pixel value with a first bit and a second bit for each of the plurality of light emitters, and the pixel circuit is configured to control each of the light emitters to emit light corresponding to the pixel values corresponding to each of the plurality of light emitters.

10. The digital display of claim 1, wherein the multi-bit pixel value comprises M groups of n bits each and the display controller is configured to separately send each of the n bits in a first one of the M groups to all of the plurality of display pixels before sending another of the n bits in a second one of the M groups to any of the plurality of display pixels.

11. A method of controlling a digital display, comprising, in order:
(i) receiving an image at a display controller, the image comprising multi-bit pixel values each comprising a first bit and a second bit;
(ii) sending the first bit to a display pixel with the display controller, the display pixel comprising a pixel memory and a light emitter;
(iii) receiving the first bit at the display pixel and storing the first bit in the pixel memory;
(iv) controlling the light emitter to emit light corresponding to the multi-bit pixel value in the pixel memory;
(v) sending the second bit to the display pixel with the display controller;
(vi) receiving the second bit at the display pixel and storing the second bit in the pixel memory; and
(vii) controlling the light emitter to emit light corresponding to the multi-bit pixel value in the pixel memory.

12. (canceled)

13. The method of claim 11, wherein the image is a first image and the method comprises repeating steps (i) to (vii) with a second image so that in step (iv) the light emitter is controlled to emit light corresponding to a first bit from the second image and a second bit from the first image.

14. The method of claim 11, wherein (i) the multi-bit pixel value comprises first bits and the method comprises sending the first bits with the display controller, (ii) the multi-bit pixel value comprises second bits and the method comprises sending the second bits with the display controller, or (iii) both (i) and (ii).

15. The method of claim 11, wherein (i) the multi-bit pixel value comprises first bits and the method comprises receiving the first bits at the display pixel and storing the first bits in the pixel memory, (ii) the multi-bit pixel value comprises second bits and the method comprises receiving the second bits at the display and storing the second bits in the pixel memory, or (ii) both (i) and (ii).

16. The method of claim 11, wherein the pixel memory comprises a first memory location and a second memory location, wherein the method comprises storing the first bit in the first memory location and storing the second bit in the second memory location.

17. The method of claim 11, wherein the multi-bit pixel value comprises M groups of n bits each and the method comprises, in order:
(i) separately sending the n bits in a first one of the M groups to the display pixel with the display controller;
(ii) receiving the n bits at the display pixel and storing the n bits in the pixel memory;
(iii) controlling the light emitter to emit light corresponding to the multi-bit pixel value stored in the pixel memory; and
(iv) repeating steps (i), (ii), and (iii) with a second one of the M groups.

18. The method of claim 17, wherein the n bits of the first one of the M groups have a first place value in the multi-bit value and the n bits of of the the second one of the M groups has a second place value that is lower than the first place value.

19. (canceled)

20. (canceled)

21. A digital display, comprising:
display pixels, each of the display pixels comprising a light emitter and a pixel circuit operable to receive and store pixel values in a pixel memory and control the light emitter to emit light corresponding to the pixel values,
wherein each of the pixel values is a multi-bit pixel value comprising M groups of n bits in each group, M>1 and n≥1; and
a display controller operable to send the pixel values to the display pixels and operable to, for each of the pixel values, successively
(i) send a group of the M groups in the pixel value to all of the display pixels;
(ii) pause for display of the group by the display pixels; and
(iii) for each different group M of n bits in the pixel value, sequentially repeat steps (i) and (ii) until all M groups of n bits in the pixel value are sent.

22. (canceled)

23. A method of controlling a digital display according to claim 21, the method comprising the steps of:
receiving a sequence of images with the display controller, each image comprising an array of image pixel values each comprising a multi-bit pixel value having n bits;
analyzing the sequence of images to determine relatively variable image portions and relatively static image portions with the display controller;
for each of the pixel values in the relatively variable image portions, sending fewer than all of the n bits of the pixel value to a corresponding display pixel of the display pixels with the display controller;
for each of the pixel values in the relatively static image portions, sending all of the n bits of the pixel value to a corresponding display pixel of the display pixels with the display controller; and
displaying the image with the display pixels.

24. The method of claim 23, wherein all of the image pixels are in the relatively variable image portions and none of the image pixels are in the relatively static image portions.

25. A digital display according to claim 21 wherein the display controller is configured to:
receive a sequence of images with the display controller, each of the images comprising an array of image pixel values each comprising a multi-bit pixel value having n bits;
analyze the sequence of images to determine relatively variable image portions and relatively static image portions with the display controller;
for each of the image pixel values in the relatively variable image portions, send fewer than all of the n bits of the image pixel value to a corresponding display pixel of the display pixels in the digital display with the display controller;
for each of the image pixels in the relatively static image portions, send all of the n bits of the pixel value to a corresponding display pixel of the display pixels in the digital display with the display controller, and
wherein the digital display is operable to display the image pixel values with the display pixels.

26. The display of claim 25, wherein all of the image pixels are in the relatively variable image portions and none of the image pixels are in the relatively static portions.

27-29. (canceled)
